(19) United States
(12) Patent Application Publication
(10) Pub. No.: US 2018/0073435 A1
(43) Pub. Date: Mar. 15, 2018

(54) NOISE-MITIGATING TRANSFER DUCT FOR ACTIVE TIP CLEARANCE CONTROL SYSTEM OF GAS TURBINE ENGINE

(71) Applicant: Pratt & Whitney Canada Corp., Longueuil (CA)

(72) Inventors: Li-Jen CHEN, Mississauga (CA); Ninad JOSHI, Brampton (CA); Sid-Ali MESLIOUI, Brossard (CA)

(21) Appl. No.: 15/260,404

(22) Filed: Sep. 9, 2016

(51) Int. Cl. F02C 7/24; F02C 3/04; F01D 11/24; F01D 17/14

(52) U.S. Cl. CPC F02C 7/24; F02C 3/04; F01D 11/24; F05D 2260/232; F05D 2260/96; F05D 2220/323; F05D 2240/14; F01D 17/148

(57) ABSTRACT

A transfer duct and an associated active tip clearance control system of a gas turbine engine are disclosed. In one embodiment, the duct comprises: an upstream duct portion for fluid communication with an air source; a downstream duct portion for fluid communication with a manifold for directing the air toward a rotor case; and a noise-mitigating device disposed between the upstream duct portion and the downstream duct portion. The duct may define an abrupt change in internal cross sectional area between the upstream duct portion and the noise-mitigating device.

### TECHNICAL FIELD

The disclosure relates generally to noise mitigation in a gas turbine engine, and more particularly to noise mitigation in an active tip clearance control system of a gas turbine engine.

### BACKGROUND OF THE ART

Conventional active tip clearance control (ATCC) systems in turbofan gas turbine engines direct some cooling air to a turbine case manifold via a duct. The cooling air is directed to flow over the turbine case through a plurality of impingement holes. A valve may be incorporated in the system to adjust the flow of cooling air flow in the ATCC system according to engine requirements such that an appropriate tip clearance between the turbine blades and the turbine shroud is maintained. An ATCC system can be noisy in some operating conditions. Improvement is desirable.

### SUMMARY

In one aspect, the disclosure describes an active tip clearance control system of a gas turbine engine. The system comprises:

a duct having an inlet in fluid communication with an air source and an outlet, the duct comprising an upstream duct portion disposed upstream of a noise-mitigating expansion chamber and a downstream duct portion disposed downstream of the noise-mitigating expansion chamber, the upstream duct portion defining a first flow passage having a first cross-sectional area and the noise-mitigating expansion chamber defining a second flow passage in fluid communication with the first flow passage and having a second cross-sectional area larger than the first cross-sectional area;

a valve configured to control air flow through the duct, the valve being disposed downstream of the duct; and

a manifold in fluid communication with the outlet of the duct via the valve and configured to receive air from the duct when the valve is at least partially open, and direct the air toward a rotor case of the gas turbine engine.

The duct may define a discontinuity in flow passage cross-sectional area between the upstream duct portion and the noise-mitigating expansion chamber.

A length of the upstream duct portion may be different from a length of the downstream duct portion.

The second cross-sectional area may be at least two times greater than the first cross-sectional area.

The second cross-sectional area may be about 2.5 times greater than the first cross-sectional area.

The downstream duct portion may define a third flow passage in fluid communication with the second flow passage and having a third cross-sectional area smaller than the second cross-sectional area.

The duct may define a discontinuity in flow passage cross-sectional area between the noise-mitigating expansion chamber and the downstream duct portion.

The first cross-sectional area and the third cross-sectional area may be substantially equal.

The source of air may comprise a core gas path of the gas turbine engine.

Embodiments may include combinations of the above features.

In another aspect, the disclosure describes an active tip clearance control system of a gas turbine engine. The system comprises:

a duct having an inlet in fluid communication with an air source and an outlet, the duct comprising an upstream duct portion disposed upstream of a noise-mitigating device and a downstream duct portion disposed downstream of the noise-mitigating device, the upstream duct portion defining a first flow passage having a first cross-sectional area and the noise-mitigating device defining a second flow passage in fluid communication with the first flow passage and having a second cross-sectional area different from the first cross-sectional area, the duct defining a discontinuity in flow passage cross-sectional area between the upstream duct portion and the noise-mitigating device;

a valve configured to control air flow through the duct, the valve being disposed downstream of the duct; and

a manifold in fluid communication with the outlet of the duct via the valve and configured to receive air from the duct when the valve is at least partially open, and direct the air toward a rotor case of the gas turbine engine.

A length of the upstream duct portion may be different from a length of the downstream duct portion.

The second cross-sectional area may be at least two times greater than the first cross-sectional area.

The second cross-sectional area may be about 40% of the first cross-sectional area.

The second cross-sectional area may be equal to or smaller than about 50% of the first cross-sectional area.

The downstream duct portion may define a third flow passage in fluid communication with the second flow passage and having a third cross-sectional area different from the second cross-sectional area.

The duct may define a discontinuity in flow passage cross-sectional area between the noise-mitigating device and the downstream duct portion.

The first cross-sectional area and the third cross-sectional area may be substantially equal.

The source of air may comprise a core gas path of the gas turbine engine.

Embodiments may include combinations of the above features.

In a further aspect, the disclosure describes a transfer duct of an active tip clearance control system of a gas turbine engine. The duct comprises:

an upstream duct portion for fluid communication with an air source, the upstream duct portion defining a first flow passage having a first cross-sectional area;

a downstream duct portion for fluid communication with a manifold for directing the air toward a rotor case; and

a noise-mitigating device disposed between the upstream duct portion and the downstream duct portion, the noise-mitigating device defining a second flow passage in fluid communication with the first flow passage and having a second cross-sectional area different from the first cross-sectional area, the duct defining a discontinuity in flow-passage cross-sectional area between the upstream duct portion and the noise-mitigating device.

The second cross-sectional area may be at least two times greater than the first cross-sectional area.

The second cross-sectional area may be equal to or smaller than about 50% of the first cross-sectional area.

The downstream duct portion may define a third flow passage in fluid communication with the second flow passage and having a third cross-sectional area different from the second cross-sectional area.

The duct may define a discontinuity in flow passage cross-sectional area between the noise-mitigating device and the downstream duct portion.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a schematic axial cross-section view of an exemplary turbo-fan gas turbine engine comprising an active tip clearance control (ATCC) system as disclosed herein;

FIG. 2 is a schematic representation of the ATCC system of the gas turbine engine of FIG. 1 according to an exemplary embodiment;

FIG. 3 is a perspective view of an exemplary duct of the ATCC system of FIG. 2 comprising a noise-mitigating device; and

FIG. 4 is a perspective view of another exemplary duct of the ATCC system of FIG. 2 comprising a noise-mitigating device.

### DETAILED DESCRIPTION

The present disclosure relates to transfer ducts for active tip clearance control (ATCC) systems of gas turbine engines. In various embodiments, the transfer ducts disclosed herein comprise noise-mitigating device(s) for reducing noise such as acoustic tones that may be produced when such transfer duct is in a close-ended configuration where an inlet of the transfer duct is exposed to a moving fluid and a downstream valve for controlling the fluid flow through the transfer duct is closed. The closed-valve configuration may represent a reflective boundary condition for sound waves and may render the transfer duct susceptible to acoustic resonance at some frequency(ies).

In various embodiments, the noise-mitigating devices disclosed herein may comprise one or more discontinuities in the cross-sectional area (e.g., and diameter) of a flow passage defined by a transfer duct. For example, such noise-mitigating devices may comprise an abrupt expansion or an abrupt constriction of a flow passage defined between an inlet and an outlet of the transfer duct. In some situations, such discontinuity(ies) in cross-sectional area may serve to mitigate (e.g., acoustic tonal) noise.

Aspects of various embodiments are described through reference to the drawings.

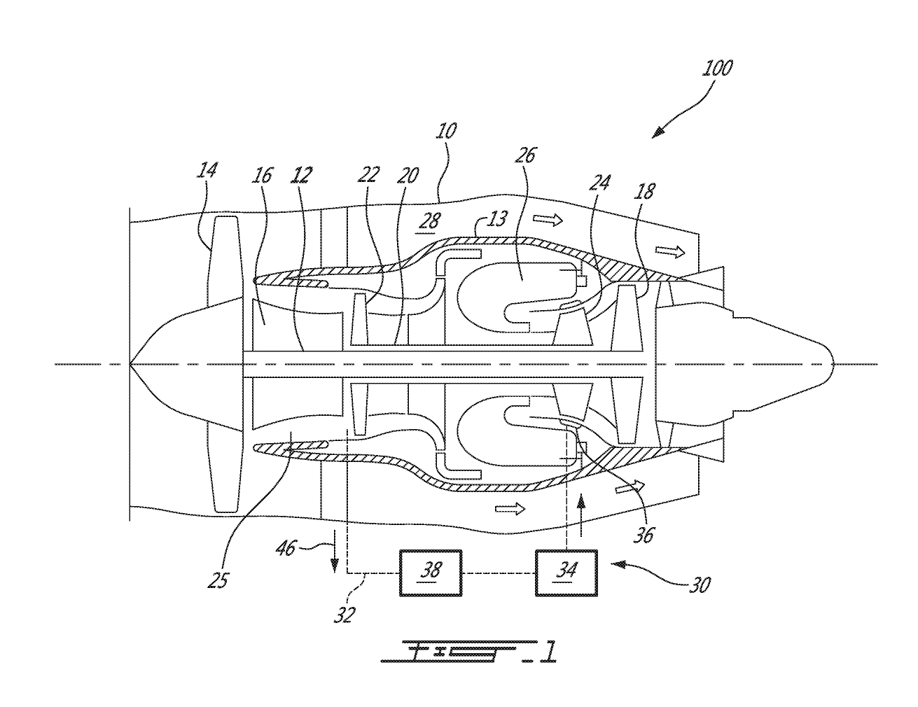

FIG. 1 schematically illustrates a turbofan gas turbine engine 100 presented as a non-limiting example and incorporating noise-mitigating aspects described herein. However, it is understood that aspects described herein may be suitable for use in other types of gas turbine engines. Engine 100 may be of a type suitable for aircraft (e.g., subsonic flight) applications. Engine 100 may comprise a housing or nacelle annular outer case 10, annular core case 13, low pressure spool 12 which may include fan 14, low-pressure compressor 16 and low-pressure turbine 18; and high-pressure spool 20 which may include high-pressure compressor 22 and high-pressure turbine 24. Low-pressure turbine 18 and high-pressure turbine 24 may each be part of multistage turbine sections. Similarly, low-pressure compressor 16 and high-pressure compressor 22 may be part of multistage compressor sections. Annular core case 13 may surround low-pressure spool 12 and high-pressure spool 20, and may define core gas path 25 therethrough. Combustor 26 may be provided in core gas path 25. Annular bypass air duct 28 may be defined radially between annular outer case 10 and annular core case 13 for directing a bypass air flow driven by fan 14, to pass therethrough and to be discharged to the ambient environment at an aft portion of engine 100 to produce thrust.

Gas turbine engine 100 may comprise an active tip clearance control (ATCC) system 30. ATCC system 30 may comprise transfer duct 32 in fluid communication with core gas path 25 at a location, for example, of a compressor section of gas turbine engine 100. In some embodiments, the location may correspond to an axial location of low-pressure compressor 16. In some embodiments, the location may correspond to an axial location downstream of low-pressure compressor 16. In some embodiments, the location may correspond to an axial location of high-pressure compressor 22. In some embodiments, the location may correspond to an axial location upstream of high-pressure compressor 22. In some embodiments, the location may correspond to an intermediate pressure location within the compressor section of gas turbine engine 100 such as, for example, an axial location between low-pressure compressor 16 and high-pressure compressor 22. Accordingly, transfer duct 32 may be configured to receive bleed air (e.g., of an intermediate pressure) from the compressor section of gas turbine engine 100. In some embodiments, the compressor bleed air received by transfer duct 32 may be of the type known as “P2.5 air”.

It is understood that transfer duct 32 may be coupled to receive cooling air from one or more different sources of air depending on the temperature and flow requirements to achieve the desired tip clearance control. For example, in some embodiments, transfer duct 32 may be configured to receive bypass air from bypass duct 28. In some embodiments, transfer duct 32 may be configured to receive a mixture of bypass air and pressurized core air (e.g., P2.5 air) to produce cooling air of a desired temperature and flow rate.

ATCC system 30 may comprise valve 34 configured to control the flow of cooling air through transfer duct 32 and one or more manifolds 36 (referred hereinafter in the singular) in fluid communication with transfer duct 32 via valve 34. Valve 34 may be of the type known as a “butterfly” valve or may be of any suitable type. Valve 34 may be actively controllable via a controller of gas turbine engine 100 such as an electronic engine controller (EEC) for example. In some embodiments, valve 34 may be configured to control the size of a flow passage from a fully closed configuration to a fully open configuration and optionally to configurations therebetween (i.e., valve 34 may be of the modulating type).

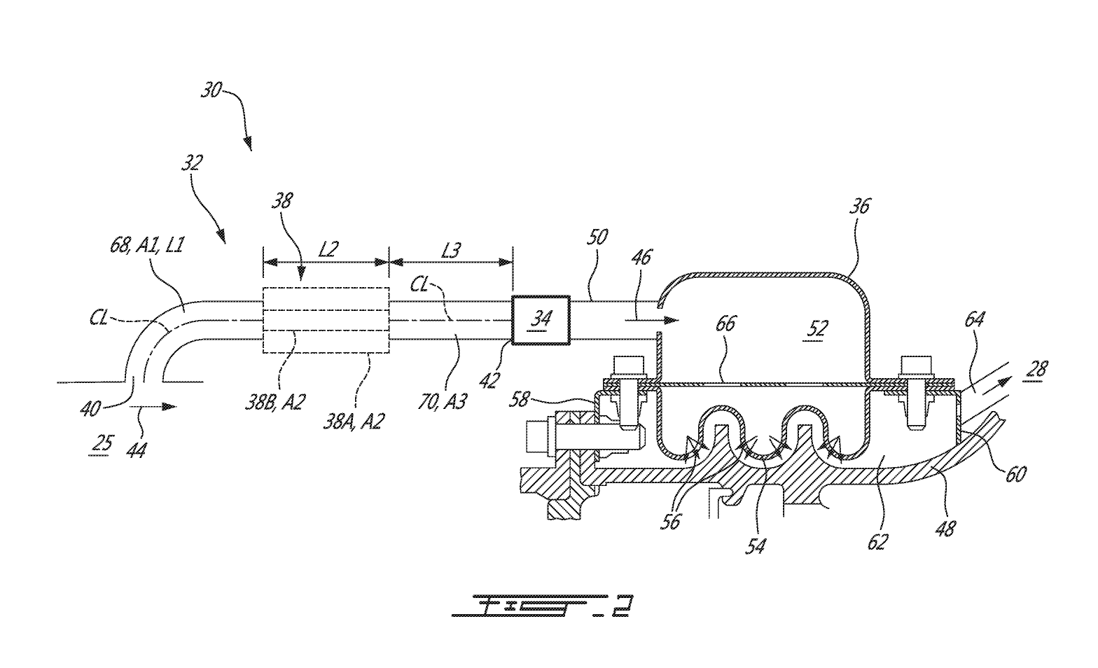

Manifold 36 may be configured to receive the cooling air from transfer duct 32 when valve 34 is at least partially open, and direct the cooling air toward a rotor case (see item 48 in FIG. 2) of gas turbine engine 100. Manifold 36 may be of any suitable type. In some embodiments, manifold 36 may be of the type described in US Patent Publication No. 2013/0156541 A1, which is incorporated herein by reference.

Transfer duct 32 may comprise one or more noise-mitigating devices 38 (referred hereinafter in the singular). In some embodiments, valve 34 may be disposed downstream of transfer duct 32. As explained further below, in some embodiments, noise-mitigating device 38 may comprise an abrupt expansion of a flow passage defined by transfer duct 32. In some embodiments, noise-mitigating device 38 may, alternatively or in addition, comprise an abrupt constriction of the flow passage defined by transfer duct 32. Transfer duct 32 is shown schematically in FIG. 1 as being located outside of annular outer case 10 for illustration purpose only. It is understood that transfer duct 32 may be located inside of outer case 10. For example, in some embodiments, transfer duct 32 may be located inside of annular core case 13.

FIG. 2 is a schematic representation of ATCC system 30 of gas turbine engine 100 according to an exemplary and non-limiting embodiment. Transfer duct 32 may have inlet 40 and outlet 42. Inlet 40 may be in fluid communication with an air source such as core gas path 25. In some embodiments, core gas path 25 may be the exclusive source of cooling air 46 for transfer duct 32. When valve 34 is at least partially open, some of the moving core air 44 may be bled out of core gas path 25 as cooling air 46 and may enter transfer duct 32 via inlet 40. As explained above, core air 44 may be pressurized and consequently heated to some extent via the compressor section of gas turbine engine 100. The temperature of core air 44 may nevertheless be at a temperature suitable to provide at least some cooling of annular turbine case 48, which is exposed to hot combustion gasses, for the purpose of controlling the thermal expansion of annular turbine case 48 for active tip clearance control via manifold 36. Manifold 36 may be in fluid communication with outlet 42 of transfer duct 32 via valve 34 and one or more delivery ducts 50. Manifold 36 may be configured to receive cooling air 46 from transfer duct 32 when valve 34 is at least partially open and direct cooling air 46 toward annular turbine case 48 of gas turbine engine 100. FIG. 2 includes an axial cross-sectional view of manifold 36 and of annular turbine case 48.

In various embodiments, annular turbine case 48 may be an outer case of low-pressure turbine 18 and/or of high-pressure turbine 24. However, it is understood that aspects of the present disclosure could also be used in conjunction with other types of rotors or rotor cases of gas turbine engine 100 for the purpose of active tip clearance control.

Manifold 36 may have an annular configuration and may extend around a turbine/rotor assembly (e.g., high pressure turbine 24 or low pressure turbine 18), for example, around annular turbine case 48 such as a turbine support case or a turbine shroud. Manifold 36 may define annular plenum 52 therein which may be in fluid communication with transfer duct 32 via valve 34 so as to receive cooling air 46 therein from transfer duct 32. Manifold 36 may include shield 54 which may be configured to contour an outer surface of turbine case 48 while maintaining a suitable space therefrom. Shield 54 may include a plurality of holes 56 defined in shield 54 to allow cooling air 46 to be discharged from the holes 56 and to impinge on the outer surface of annular turbine case 48 in order to cool annular turbine case 48 and other turbine components (not shown) which are directly connected to turbine case 48, thereby reducing blade tip clearances.

ATCC system 30 may include mounting devices for securing manifold 36 to turbine case 48. For example, a plurality of mounting brackets which mount the manifold 36 on the annular turbine case 48 may be connected circumferentially one to another to form respective forward and after annular sealing walls 58, 60 extending radially between the manifold 36 and turbine case 48 in order to thereby define a sealed annular cavity 62 between manifold 36 and annular turbine case 48. Venting passage 64 of ATCC system 30 may be in fluid communication with annular cavity 62 via, for example, aft annular sealing wall 60. Venting passage 64 may be in fluid communication with the atmosphere via, for example, bypass air duct 28 for discharging cooling air 46 after it has impinged upon turbine case 48. ATCC system 30 may be substantially sealed to prevent leakage or other discharge of cooling air 46 out of ATCC system 30 except via venting passage 64. An optional divider 50 with a plurality of openings (not numbered) within the annular plenum 52 may be provided to improve pressure distribution within manifold 36.

In some embodiments, noise-mitigating device 38 may comprise an expansion 38A (e.g., a section of expanded diameter) of a flow passage defined between inlet 40 outlet 42 of transfer duct 32. For example, noise-mitigating device 38 may comprise an expansion chamber 38A defining an internal flow passage having a larger cross-sectional area than other part(s) (e.g., the remainder) of transfer duct 32. Alternatively or in addition, noise-mitigating device 38 may comprise a constriction 38B (e.g., a section of reduced diameter) of the flow passage defined between inlet 40 outlet 42 of transfer duct 32. Such constriction section 38B may define an internal flow passage having a smaller cross-sectional area than other part(s) (e.g., the remainder) of transfer duct 32. In some embodiments, noise-mitigating device 38 may comprise a plurality of expansion chambers 38A or a plurality of constriction sections 38B. In some embodiments, noise-mitigating device 38 may comprise one or more expansion chambers 38A in combination with one or more constriction sections 38B.

Transfer duct 32 may comprise upstream duct portion 68 disposed upstream of noise-mitigating device 38 and downstream duct portion 70 disposed downstream of noise-mitigating device 38. A length L1 of upstream duct portion 68 may be different from a length L3 of downstream duct portion 70. In some embodiments, a length L1 of upstream duct portion 68 may be greater than a length L3 of downstream duct portion 70. In some embodiments, a length L3 of downstream duct portion 70 may be greater than a length L1 of upstream duct portion 68. Lengths referred herein are intended to be measured along a centerline CL of transfer duct 32 whether such centerline CL is linear or is non-linear. Upstream duct portion 68 may define a first flow passage having a first cross-sectional area A1 and noise-mitigating device 38 may define a second flow passage having a second cross-sectional area A2.

In an embodiment where noise-mitigating device 38 comprises an expansion chamber 38A, second cross-sectional area A2 of such expansion chamber 38A would be larger than the first cross-sectional area A1 and/or than third cross-sectional area A3. In some embodiments, second cross-sectional area A2 may be at least two times greater than first cross-sectional area A1. In some embodiments, second cross-sectional area A2 may be about 2.5 times greater than first cross-sectional area A1. In some embodiments, second cross-sectional area A2 may be at least two times greater than third cross-sectional area A3. In some embodiments, second cross-sectional area A2 may be about 2.5 times greater than third cross-sectional area A3. In various embodiments, first cross-sectional area A1 and third cross-sectional area A3 may be of substantially equal size or may be of different sizes.

In an embodiment where noise-mitigating device 38 comprises a constriction section 38B, second cross-sectional area A2 of such constriction section 38B would be smaller than the first cross-sectional area A1 and/or than third cross-sectional area A3. In some embodiments, second cross-sectional area A2 may be equal to or smaller than about 50% of first cross-sectional area A1. In some embodiments, second cross-sectional area A2 may be equal to or smaller than about 50% of third cross-sectional area A3. In some embodiments, a size of second cross-sectional area A2 may be about 40% of a size of first cross-sectional area A1. In some embodiments, the size of second cross-sectional area A2 may be about 40% of a size of third cross-sectional area A3.

In some embodiments, transfer duct 32 may define a discontinuity in flow passage cross-sectional area between upstream duct portion 68 and noise-mitigating device 38. For example, transfer duct 32 may comprise an abrupt transition (i.e., sudden change, jump) from first cross-sectional area A1 to second cross-sectional area A2. Similarly, in some embodiments, transfer duct 32 may define a discontinuity in flow passage cross-sectional area between noise-mitigating device 38 and downstream duct portion 70. For example, transfer duct 32 may comprise an abrupt transition from second cross-sectional area A2 to third cross-sectional area A3. For example, such abrupt transition may comprise a single step transitioning from a cross-sectional area of one size to a cross-sectional area of a different size. Such abrupt transition may comprise a sudden increase or decrease in internal dimension (e.g., diameter) of transfer duct 32. In various embodiments, the flow passages defined by one or more of upstream duct portion 68, noise-mitigating device 38 and downstream duct portion 70 may have a circular or a non-circular cross-sectional profile.

During operation of gas turbine engine 100, since valve 34 is disposed at some (non-zero) distance downstream of inlet 40 of transfer duct 32, the closing of valve 34 may produce a reflective boundary condition for sound waves travelling inside of transfer duct 32. The closing of valve 34 downstream of transfer tube 32 during some operating condition(s) of gas turbine engine 100 may result in a closed-ended (i.e., capped) tube of length L1+L2+L3 that is exposed to a moving fluid (i.e., core air 44) at its inlet 40. Depending on the resonant frequency of transfer tube 32, the moving core air 44 may induce tonal noise that may contribute to the overall noise level of gas turbine engine 100. In other words, the close-ended transfer tube 32 may result in a condition that favors acoustic resonance at some frequency(ies) when there is a frequency-matching flow excitation at inlet 40.

The presence of noise-mitigating device 38 may help mitigate such tonal noise. The presence of an expansion chamber 38A or a constriction section 38B may, in some embodiments, alter the acoustic resonance of close-ended transfer tube 32, which may result in a new acoustic resonance frequency(ies) away from the flow excitation frequency(ies) at inlet 40. This frequency mismatch may prevent the tone from being further strengthened through a fluid-sound interaction. Other secondary mechanisms may also be involved in some embodiments. For example, for an expansion chamber, the sudden expansion and contraction of the sound waves can cause a change of phase of the waves and some noise cancellation effect at the desired frequency or frequency range. The presence of an expansion chamber 38A or a constriction section 38B, may provide impedance to the sound waves travelling through transfer duct 32 either from inlet 40 toward outlet 42 or from outlet 42 toward inlet 40 due to the close-ended configuration of transfer duct 32 when valve 34 is closed. For example, such expansion chamber 38A or constriction section 38B may function as a reactive silencer at the frequency(ies) of interest and mitigate tonal noise.

The specific configuration (e.g., dimensions and positioning along transfer duct 32) of noise-mitigating device(s) 38 may depend on the specific installation constraints, the noise frequency(ies) to be mitigated and the performance requirements of transfer duct 32. For example, in some embodiments, it may be desirable that noise-mitigating device 38 be positioned at a location that is not equidistant to inlet 40 and outlet 42.

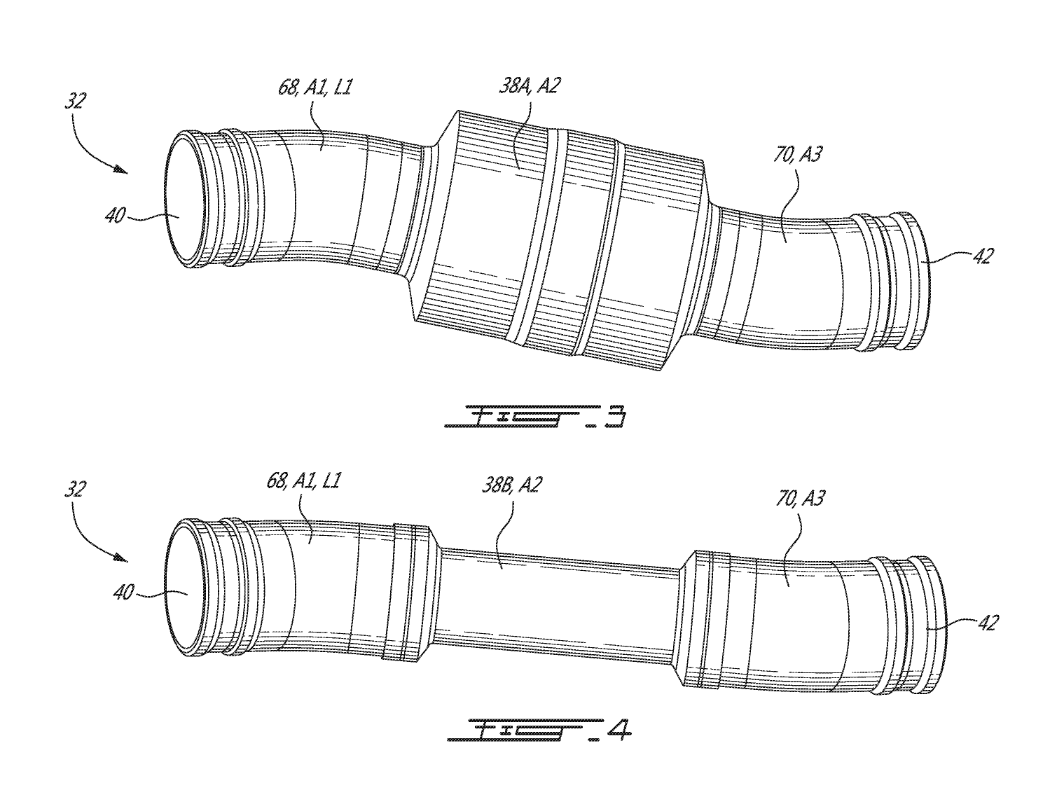

FIG. 3 is a perspective view of an exemplary transfer duct 32 of ATCC system 30 of FIG. 2 according to one embodiment where noise-mitigating device 38 comprises expansion chamber 38A.

FIG. 4 is a perspective view of an exemplary transfer duct 32 of ATCC system 30 of FIG. 2 according to another embodiment where noise-mitigating device 38 comprises constriction section 38B.

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. Also, one skilled in the relevant arts will appreciate that while the systems, ducts and assemblies disclosed and shown herein may comprise a specific number of elements/components, the systems, ducts and assemblies could be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

What is claimed is:

1. An active tip clearance control system of a gas turbine engine, the system comprising:
a duct having an inlet in fluid communication with an air source and an outlet, the duct comprising an upstream duct portion disposed upstream of a noise-mitigating expansion chamber and a downstream duct portion disposed downstream of the noise-mitigating expansion chamber, the upstream duct portion defining a first flow passage having a first cross-sectional area and the noise-mitigating expansion chamber defining a second flow passage in fluid communication with the first flow passage and having a second cross-sectional area larger than the first cross-sectional area;
a valve configured to control air flow through the duct, the valve being disposed downstream of the duct; and
a manifold in fluid communication with the outlet of the duct via the valve and configured to receive air from the duct when the valve is at least partially open, and direct the air toward a rotor case of the gas turbine engine.

2. The system as defined in claim 1, wherein the duct defines a discontinuity in flow passage cross-sectional area between the upstream duct portion and the noise-mitigating expansion chamber.

3. The system as defined in claim 1, wherein a length of the upstream duct portion is different from a length of the downstream duct portion.

4. The system as defined in claim 1, wherein the second cross-sectional area is at least two times greater than the first cross-sectional area.

5. The system as defined in claim 1, wherein the second cross-sectional area is about 2.5 times greater than the first cross-sectional area.

6. The system as defined in claim 1, wherein the downstream duct portion defines a third flow passage in fluid communication with the second flow passage and having a third cross-sectional area smaller than the second cross-sectional area, the duct defining a discontinuity in flow passage cross-sectional area between the noise-mitigating expansion chamber and the downstream duct portion.

7. The system as defined in claim 6, wherein the first cross-sectional area and the third cross-sectional area are substantially equal.

8. The system as defined in claim 1, wherein the source of air comprises a core gas path of the gas turbine engine.

9. An active tip clearance control system of a gas turbine engine, the system comprising:
a duct having an inlet in fluid communication with an air source and an outlet, the duct comprising an upstream duct portion disposed upstream of a noise-mitigating device and a downstream duct portion disposed downstream of the noise-mitigating device, the upstream duct portion defining a first flow passage having a first cross-sectional area and the noise-mitigating device defining a second flow passage in fluid communication with the first flow passage and having a second cross-sectional area different from the first cross-sectional area, the duct defining a discontinuity in flow passage cross-sectional area between the upstream duct portion and the noise-mitigating device;
a valve configured to control air flow through the duct, the valve being disposed downstream of the duct; and
a manifold in fluid communication with the outlet of the duct via the valve and configured to receive air from the duct when the valve is at least partially open, and direct the air toward a rotor case of the gas turbine engine.

10. The system as defined in claim 9, wherein a length of the upstream duct portion is different from a length of the downstream duct portion.

11. The system as defined in claim 9, wherein the second cross-sectional area is at least two times greater than the first cross-sectional area.

12. The system as defined in claim 9, wherein the second cross-sectional area is about 40% of the first cross-sectional area.

13. The system as defined in claim 9, wherein the second cross-sectional area is equal to or smaller than about 50% of the first cross-sectional area.

14. The system as defined in claim 9, wherein the downstream duct portion defines a third flow passage in fluid communication with the second flow passage and having a third cross-sectional area different from the second cross-sectional area, the duct defining a discontinuity in flow passage cross-sectional area between the noise-mitigating device and the downstream duct portion.

15. The system as defined in claim 14, wherein the first cross-sectional area and the third cross-sectional area are substantially equal.

16. The system as defined in claim 9, wherein the source of air comprises a core gas path of the gas turbine engine.

17. A transfer duct of an active tip clearance control system of a gas turbine engine, the duct comprising:
an upstream duct portion for fluid communication with an air source, the upstream duct portion defining a first flow passage having a first cross-sectional area;
a downstream duct portion for fluid communication with a manifold for directing the air toward a rotor case; and
a noise-mitigating device disposed between the upstream duct portion and the downstream duct portion, the noise-mitigating device defining a second flow passage in fluid communication with the first flow passage and having a second cross-sectional area different from the first cross-sectional area, the duct defining a discontinuity in flow-passage cross-sectional area between the upstream duct portion and the noise-mitigating device.

18. The transfer duct as defined in claim 17, wherein the second cross-sectional area is at least two times greater than the first cross-sectional area.

19. The transfer duct as defined in claim 17, wherein the second cross-sectional area is equal to or smaller than about 50% of the first cross-sectional area.

20. The transfer duct as defined in claim 17, wherein the downstream duct portion defines a third flow passage in fluid communication with the second flow passage and having a third cross-sectional area different from the second cross-sectional area, the duct defining a discontinuity in flow passage cross-sectional area between the noise-mitigating device and the downstream duct portion.
